(19) United States
(12) Patent Application Publication
(10) Pub. No.: US 2008/0311776 A1
(43) Pub. Date: Dec. 18, 2008

(54) Well Completion Self Orienting Connector system

(75) Inventors: Morris W. Cox, McKinney, TX (US); Robert W. Crow, Irving, TX (US); Brent M. Green, Dallas, TX (US); Ronald W. McGregor, Carrollton, TX (US)

Correspondence Address: CONLEY ROSE, P.C., 5601 GRANITE PARKWAY, SUITE 750, PLANO, TX, 75024, US

(73) Assignee: HALLIBURTON ENERGY SERVICES, INC., Carrollton, TX (US)

(21) Appl. No.: 11/764,387

(22) Filed: Jun. 18, 2007

(51) Int. Cl. H01R 4/60; E21B 43/00

(52) U.S. Cl. 439/192; 166/313

(57) ABSTRACT

A well completion system, including a packer and a lower signal line connector carried on tubing below the packer. An upper signal line connector is carried on an upper tubing section. The upper tubing is adapted for lowering through the packer into sealing contact with the lower tubing and for operatively connecting the upper signal line connector to the lower signal line connector. A lug on the upper tubing and a profile in the lower tubing interact to rotate the upper connector into alignment with the lower connector. An upper signal line extends from a surface location down the upper tubing to the upper connector. A lower signal line extends from the lower connector down the lower tubing to downhole sensors and/or actuators.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present invention relates to well completions including signal or control lines and more particularly to a self orienting connector system for connecting an upper portion of a signal or control line to a lower portion thereof while installing a well completion.

### BACKGROUND OF THE INVENTION

Wells are drilled into the Earth to explore for and produce hydrocarbons and other fluids. If hydrocarbons are to be produced, the well must be completed. Completing a well typically includes setting and cementing casing in at least an upper portion of a well and installing other equipment to facilitate, control and monitor production of fluids. Such equipment may include a gravel packing assembly to restrict the production of sand with the desirable fluids. Temperature and pressure sensors are commonly installed to monitor conditions, especially in the lower completion, i.e. in and near productive zones. Valves, and actuators to control the valves, may be installed to control the flow of fluids. Signal and control lines are desirably provided from the downhole equipment to the surface location of the well to allow sensor outputs to be read and recorded and to allow control signals to be sent to the downhole equipment.

A lower completion typically includes equipment extending from the cased and cemented portion of the well down to and through producing formations. The basic structural component of a lower completion is a tubing or flow line through which fluids produced from the Earth are flowed up the well. The upper end of a lower completion typically includes a packer that provides an annular seal between the upper end of the flow line and the inner surface of the casing. The lower completion is installed before the upper completion, and may be installed weeks or months before the upper completion is installed, especially in the case of a sub-sea well. The lower completion normally contains signal and control lines needed for the sensors, valves, etc. included in the lower completion.

An upper completion includes a flow line that extends from the surface location of the well down to the packer where it is connected to the upper end of the lower completion to form a continuous flow path from the productive zone to the surface of the Earth. The upper completion may also include signal and control lines that extend from the surface of the Earth down to the packer for connection to the upper ends of the signal and control lines that were installed as part of the lower completion.

In prior art completions, signal and control lines forming part of a lower completion are terminated above the packer. Upon installation of the upper completion, the connections to the portion of the signal and control lines forming part of the upper completion are made above the packer. This prior art arrangement requires that a separate conduit or interior flow path be provided through the packer, normally through the packer mandrel, for the signal and control line or lines. The primary conduit or interior flow path through a packer is used for the production tubing and is desirably as large as possible. If one or more additional interior flow paths is required for signal or control lines, the size of the primary flow path must be reduced.

### SUMMARY OF THE INVENTION

A well completion system includes a lower completion comprising a packer, a first length of production tubing having an upper end coupled to the packer, and a lower signal line connector positioned below the packer. An upper completion includes a second length of production tubing and an upper signal line connector, the upper completion adapted to make operative connection between the upper signal line connector and the lower signal line connector below the packer.

In an embodiment, the upper completion includes an orientation lug and the lower completion includes an orientation sleeve having a scooped profile, whereby upon movement of the upper completion into the lower completion, the orientation lug follows the scooped profile and rotates the upper completion relative to the lower completion to align the upper connector and lower connector.

In an embodiment, the upper completion includes an alignment nose and the lower completion includes a complementary alignment recess. When the upper completion is lowered into the lower completion, the alignment nose enters the alignment recess and further aligns the upper and lower connectors.

In an embodiment, the upper completion includes a cylindrical outer surface on its lowermost end and the lower completion includes a complementary cylindrical bore. When the upper completion is lowered into the lower completion, the lowermost end of the upper completion enters the complementary bore and further aligns the upper and lower connectors.

### BRIEF DESCRIPTION OF THE DRAWINGS

FIG. 1 is a generalized diagram of an oil or gas well completion including signal line connectors according to the present invention.

FIGS. 2A and 2B together provide a perspective view of an upper completion connector carrier.

FIGS. 3A and 3B together provide a cross sectional view of the upper completion connector carrier and a protective sleeve in a run-in configuration.

FIGS. 4A and 4B together provide a cross sectional view of a lower completion connector carrier.

FIG. 5 is a perspective view of a portion of the lower connector carrier.

FIGS. 6A and 6B together provide a cross sectional view of an assembly having the upper completion connector carrier installed in the lower completion connector carrier.

### DETAILED DESCRIPTION OF THE PREFERRED EMBODIMENTS

In the present disclosure, a first element may be described as upper, above, or uphole relative to a second element, which second element may be described as lower, below or downhole relative to the first element. The top of a well is at the surface of the Earth, which may be below water in a sub-sea well, and the bottom is the end of the well opposite the top, even though the bottom may not be directly below the top and may be horizontally displaced by a substantial distance. Portions of a well may be slanted or even horizontal. In a horizontal well, the first element would still be referred to as uphole or above the second element because it is closer to the surface end of the well.

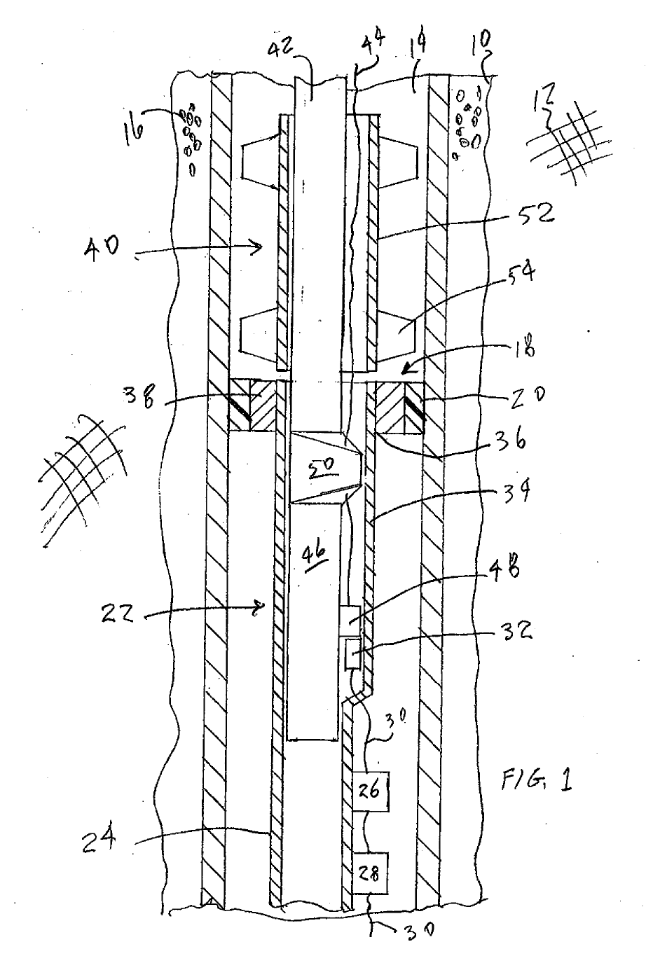

A general description of an embodiment is provided with reference to FIG. 1 which provides a somewhat block diagram illustration of an oil or gas well completion including a signal line connector system according to the present invention. A well 10 has been drilled through Earth formation 12. A casing 14, normally steel, has been installed within well 10 and at least some of the space between casing 14 and well 10 has been filled with cement 16. A packer 18, including elastomeric seals or elements 20, has been installed in the casing 14.

A lower completion 22 has been installed in the well 10 extending downhole from packer 18. The packer 18 may be installed with and as part of the lower completion 22. The lower completion 22 includes a length of tubing 24 which extends down well 10 to one or more productive zones from which fluids may be produced. The produced fluids are desirably produced or flowed uphole through the tubing 24. The lower completion 22 also includes sensors 26, e.g. temperature, pressure, and/or flow rate sensors, and actuators 28 which may, e.g., open and close valves. The sensors 26 and actuators 28 may be connected to one or more signal lines 30 for transmitting sensor 26 outputs uphole and/or transmitting control signals downhole to the sensors 26 and/or actuators 28. The upper end of signal line 30 terminates in a connector 32. In the prior art, the connector 32 was positioned above the packer 18, which packer would include a separate interior flow path for the signal line 30. In this embodiment, the connector 32 is carried on the lower completion 22 and is positioned below the packer 18, so that no separate interior flow path through packer 18 is required for the signal line 30 or connector 32.

On the upper end of tubing 24 is formed an enlarged portion 34, which may be a separate element attached by threaded connections as are typically used to connect oil field tubular elements, e.g. tubing, casing, liners, etc. The portion 34 is referred to herein as the lower carrier or lower connector carrier, because it carries the connector 32 which is part of the lower completion 22. In this embodiment, connector 32 is a female signal line connector or receptacle, for example the female portion of an optical fiber connector system having part number DHCE-B36-BB-01P-000-00 sold by Tronic, Limited. The upper end of the lower connector carrier 34 is connected to an internal flow path 36 through packer 18 mandrel 38 by a threaded connection, although it could be welded to, or formed as an integral part of, the packer 18 mandrel 38.

An upper completion 40 includes a length of tubing 42 which extends from the surface location of well 10 down to the packer 18 and the lower connector carrier 34. An upper signal line 44 is carried on the tubing 42 and also extends from the well 10 surface location down to the lower completion 22 where it needs to be operatively connected to the lower completion signal line 30. On the lower end of the tubing 42 is formed or attached an upper connector carrier 46 which, in this embodiment, carries a male connector 48. The upper connector 48 is connected to the lower end of upper signal line 44 and is adapted for making an operative connection with the lower connector 32, thereby allowing signals to pass between the signal lines 30 and 44. In this embodiment, the upper connector is the male portion of an optical fiber connector system.

The upper carrier 46 includes at least one enlarged portion, or seal body, 50 having seals, e.g. O-rings, on its outer surface and adapted to form a fluid tight seal with an inner surface, or seal bore, of the lower carrier 34. When such a seal is formed, a continuous fluid flow path is formed between the lower completion tubing 24 and the upper completion tubing 42. As illustrated, the enlarged portion 50 also includes a conduit through which the signal line 44 passes. Sealing means, e.g. O-rings or a cured-in-place material such as epoxy or elastomer, is provided between the signal line 44 and the enlarged portion 50 to restrict fluid flow past the portion 50.

Also illustrated in FIG. 1 is a protective sleeve 52 carried on tubing 42. The sleeve 52 includes centralizing fins 54 on its outer surface to keep the sleeve 52 generally centered in the casing 14. In a run-in configuration, the sleeve 52 is positioned around the upper carrier 46 to protect seals on the enlarged portion 50 and the upper connector 48 from damage as the upper completion is lowered down well 10 to the packer 18. Since the centralizer fins 54 keep the sleeve 52 centered in casing 14, the sleeve keeps the upper carrier 46 centered in the casing 14 and aligns it with the interior flow path 36 through the mandrel 38 of packer 18. The sleeve 52 is preferably held in place on the upper completion by shear pins or some other type of releasable locking mechanism. When the upper completion reaches the packer 18, the sleeve 52 contacts the packer 18 and continued downward movement of the tubing 42 and upper carrier 46 shears the shear pins or otherwise releases the locking mechanism, so that the upper carrier 40 may pass through the packer 18, while the sleeve 52 stops and remains above the packer 18, as illustrated in FIG. 1.

More details of an embodiment are shown in the following figures. Such details include elements which automatically align the upper connector 48 with the lower connector 32 as the upper completion 40 is lowered into operative engagement with the lower completion 22.

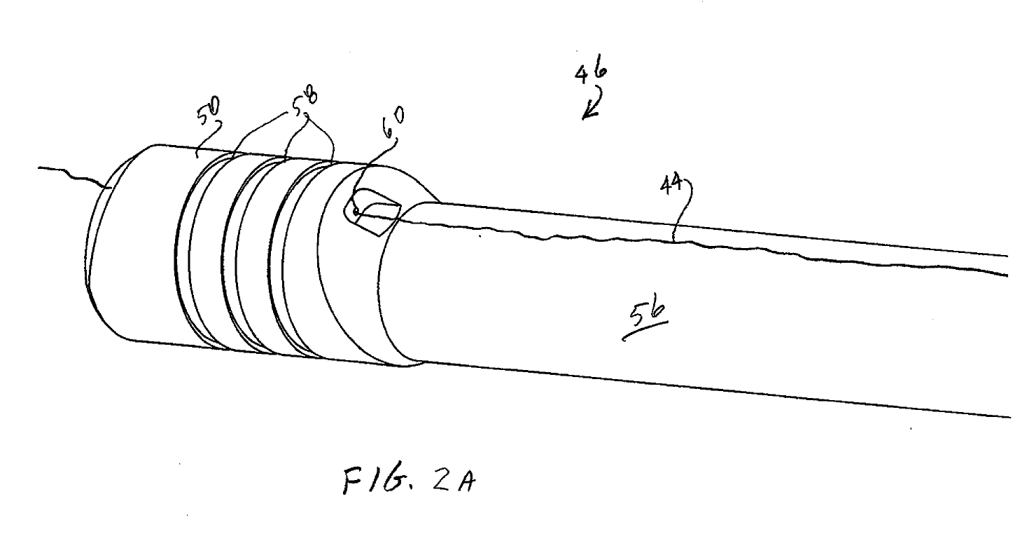

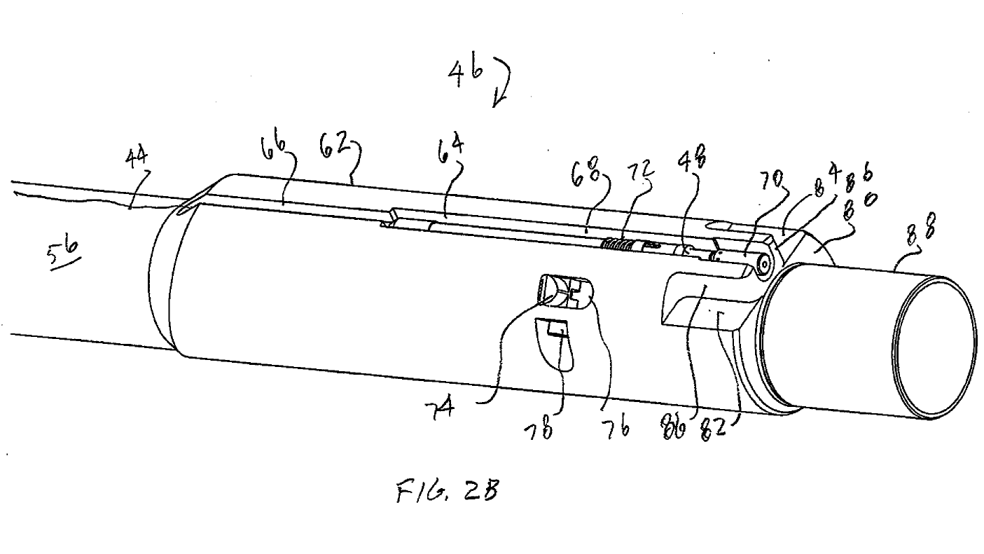

With reference to FIGS. 2A and 2B (referred to collectively as FIG. 2), more details of the upper carrier 46 will be described. Reference numbers used to identify various elements in FIG. 1 are used for the same elements in FIG. 2. In FIG. 2A, the upper end of upper carrier 46 includes the enlarged portion, or seal body, 50. The seal body 50 is cylindrical in shape, but is eccentric relative to a central portion 56 which forms an extension of the tubing 42 (FIG. 1). The seal body 50 includes grooves 58 for O-rings or other seal elements. It also includes a small port 60 extending between the upper and lower ends of the seal body 50 sized to allow the signal line 44 to pass through and bypass the seal body 50. Any space between the signal line 44 and the port 60 may be filled with a pressure resistant sealing material, for example a cured in place epoxy or elastomer such as silicone rubber.

FIG. 2B illustrates the lower end of upper carrier 46, and includes a second enlarged and eccentric portion 62. A groove 64 is formed along the length of the portion 62. The groove 64 includes a first part 66 sized to receive the signal line 44, and a second, normally wider, part 68 for receiving the upper connector 48 connected to the lower end of signal line 44. The lowermost end 70 of the connector 48 is movable to a limited extent within the groove 68 and a spring 72 is provided for urging the end 70 downward to maintain operable contact with the lower connector 32 in the lower completion when the upper completion has been installed.

The enlarged portion 62 includes several elements which operate to automatically position the upper connector 48 in proper alignment with the lower connector 32 as the upper completion is installed in the well 10. An orientation key or lug 74 is carried in a recess 76 and pivots on a cap screw 78. A spring, not shown, urges the lug 74 to its extended position as shown in FIG. 2B. In the run-in condition, the sleeve 52 holds the lug 74 in the recess 76. The orientation operation of the lug is described in more detail below. A face 80 forming the lower end of the enlarged portion 62 is recessed on both sides 82 of groove 68 to form a nose 86 that also aligns the upper connector 48 for proper assembly. A short tubing section 88, aligned with the central tubing 56 extends below the enlarged portion 62 and serves several purposes. One of those purposes is to help align the upper connector 48 with the lower connector 32. During installation of the upper completion, each of these three alignment elements interacts with corresponding elements in the lower completion to align the upper connector 48 with the lower connector 32. These alignment elements are in addition to beveled edges normally provided on commercially available connectors 48 and 32 which also provide alignment as the connectors are engaged.

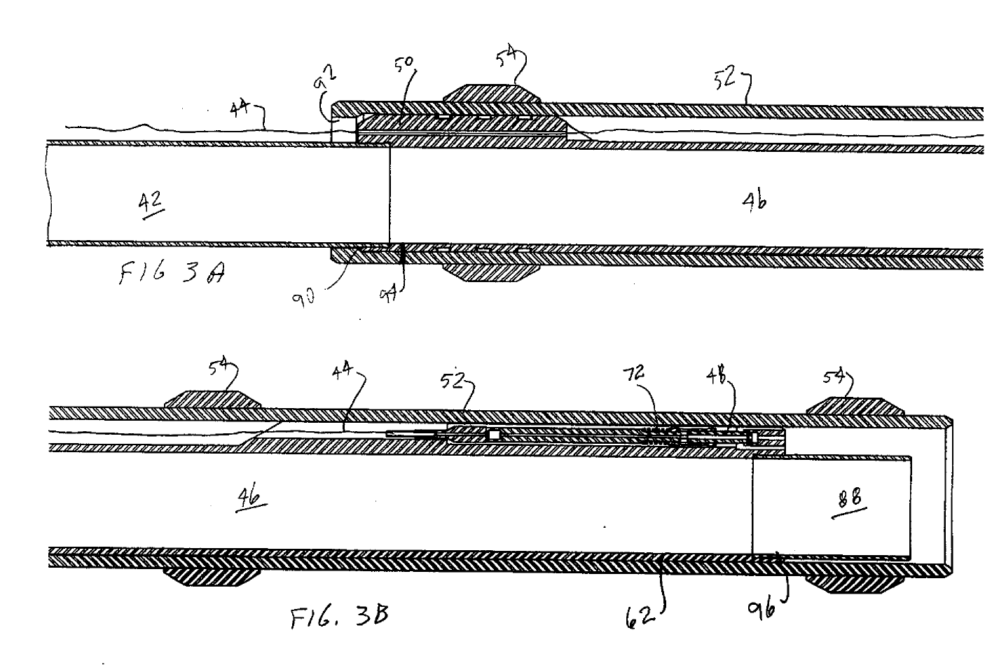

With reference to FIGS. 3A and 3B (collectively referred to as FIG. 3), the run-in configuration of the upper connector carrier 46 and protective sleeve 52 will be described. Reference numbers used for elements shown in FIGS. 1 and 2 are used for the same parts shown in FIG. 3. The upper carrier 46 is shown as positioned entirely within the sleeve 52 to protect the carrier 46 from damage that may be caused by contact with casing 14 as the upper completion is lowered into the well 10. The upper end of the carrier 46 is connected to the tubing 42 by a threaded or welded connection at 90. An inner shoulder 92 on the upper end of sleeve 52 engages the upper end of seal body 50 and prevents the sleeve 52 from moving down relative to the upper carrier 46. A shear pin 94 may be provided to prevent sleeve 52 from moving up relative to the upper carrier until sufficient force is applied to shear the pin 94. The tubing extension 88 may be a short section of tubing connected to the lower enlarged portion 62 by a threaded or welded connection at 96.

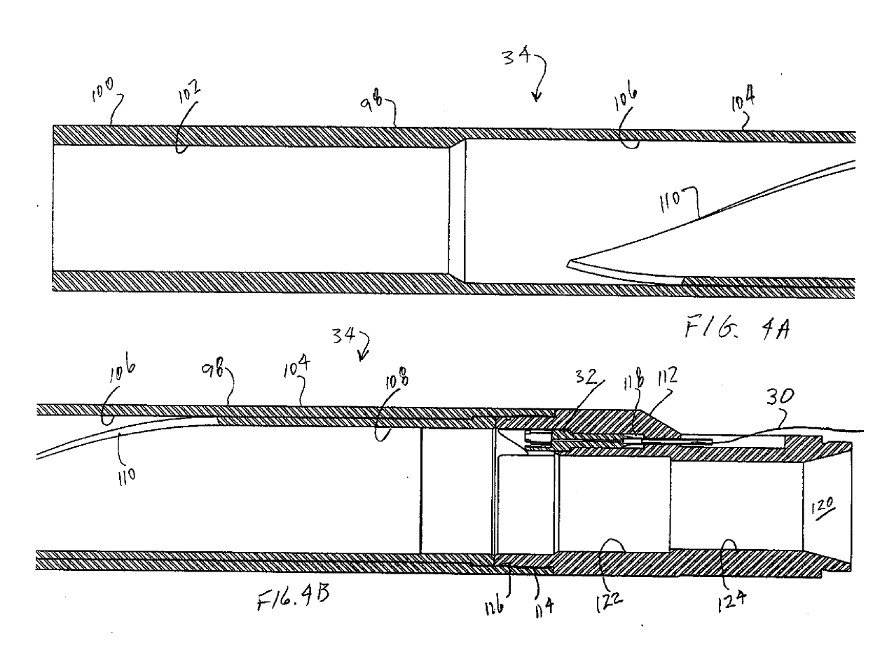

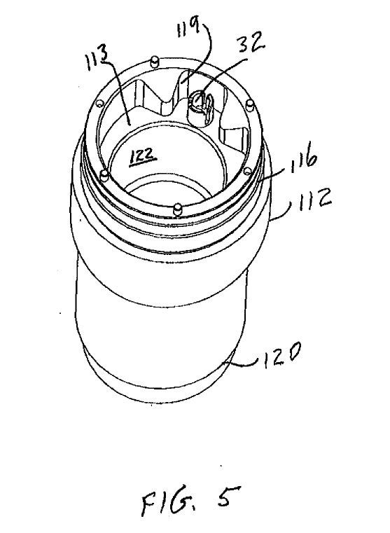

With reference to FIGS. 4A and 4B (collectively referred to as FIG. 4), more details of the lower connector carrier 34 are provided in a cross sectional view. FIG. 5 provides a perspective view of a lower portion 112 of the lower connector carrier 34. Reference numbers used for elements shown in FIG. 1 are used for the same parts shown in FIGS. 4 and 5. The lower carrier 34 includes an outer cylindrical mandrel 98 forming the main structural element of the lower carrier 34. An upper end 100 of mandrel 98 has an inner diameter 102 forming a seal bore, i.e. adapted to form a fluid seal with the seal body 50 shown in FIGS. 1 and 2A. The upper end 100 is also adapted to be connected to the interior flow path 36 through packer 18 mandrel 38, e.g. by a threaded or welded connection.

A lower portion 104 of the mandrel 98 has a larger inner diameter 106 than the upper portion 100. Carried within lower portion 104 is an orientation sleeve 108 having a scooped profile 110 adapted for engaging the orientation lug 74 on upper carrier 46 and rotating the upper carrier 46 into proper alignment with the lower carrier 34 as the upper carrier 46 is lowered into the lower carrier 34.

A collar 112 is attached to the lower end 104 of mandrel 98 by a threaded connection 114 and seal 116. Collar 112 includes a bore 118 within which is carried the lower connector 32. The bore 118 extends through a wall of the collar 118 so that the connector 32 may be connected to the signal line 30 which is carried on the outside of the lower completion. The lower signal line 30 extends from the connector 32 down the tubing 24 as shown in FIG. 1. The lowermost end 120 of collar 112 is threaded for connection to the tubing 24. An inner diameter portion 122 of collar 112 is sized to form a close fit with the tubing extension 88 on the lower end of the upper carrier 46, see FIG. 2B. An inner diameter portion 124 of collar 112, located below the portion 122, has a smaller inner diameter corresponding generally to the inner diameter of tubing 24 and extension 88.

As illustrated best in FIG. 5, the collar 112 includes a recess 119 within which is carried the uppermost end of the lower connector 32. The recess 119 is sized and shaped to receive the nose 86 of the upper carrier 46. In this embodiment, the upper connector 48 is centered in the nose 86 and the lower connector 32 is centered in the recess 119, so that when the nose 48 enters the recess 119, the upper connector 48 is aligned with the lower connector 32.

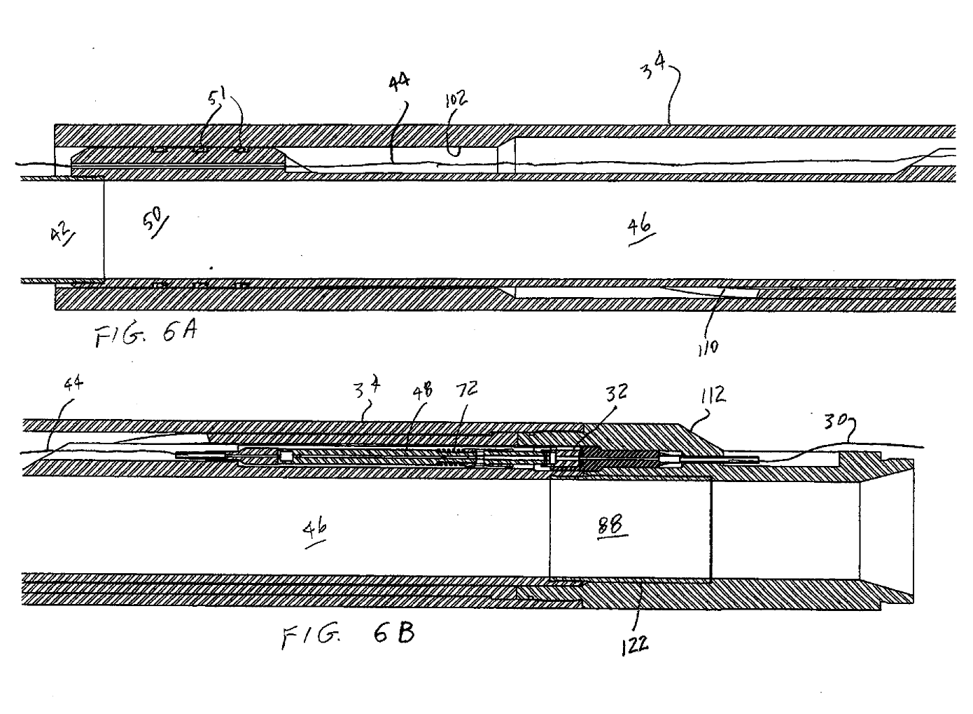

With reference to FIGS. 6A and 6B (collectively referred to as FIG. 6) more details of the upper connector carrier 46 installed in the lower connector carrier 34 are provided in a cross sectional view. As shown in FIG. 6, the upper carrier 46 has been lowered into the lower carrier 34 until the lower tubing extension 88 has entered and bottomed out into the collar 112 portion 122. At this point, the face 80 (FIG. 2B) forming the lower end of the enlarged portion 62 (FIG. 2B) has also bottomed out on a surface 113 on the upper end of the collar 112 (FIG. 5) and the nose 86 (FIG. 2B) has entered the complementary recess 119 on the upper end of collar 112. The lowermost end 70 of upper connector 48 has entered the lower connector 32 and completed an operative connection between the lower signal line 30 and the upper signal line 44. The spring 72 is partially compressed to provide a positive force holding the connectors 48 and 32 in constant contact.

In operation, the lower carrier 34 is assembled as shown in FIG. 4, and connected between a packer 18 and tubing 24, all forming part of a lower completion 22, FIG. 1. The lower completion may also include the sensors 26, actuators 28, signal line 30, and other downhole assemblies such as sand screens and gravel packing assemblies connected to the tubing 24 below lower carrier 34. The lower completion 22 is then lowered down well 10 to a desired location and the packer 18, which may also include slips or a casing hanger, is actuated to seal the annulus between casing 14 and the lower completion 22, and provide support for the lower completion 22. Once the lower completion equipment is in place, various well treatments or other operations, such as gravel packing, fracturing, cementing, etc., may be performed in the well below packer 18.

When it is desired to place the well 10 on production, the upper completion 40 must be installed to complete a flow path from the producing zone or zones to the surface. In operation, the upper carrier 46 is assembled as illustrated in FIGS. 1, 2, and 3 with the protective sleeve 52 and connected to the lower end of the tubing 42 to form the upper completion 40. The upper completion 40 is then lowered down well 10. As it is lowered, the protective sleeve 52 protects the upper carrier 46 from contact with the well casing 14 and the centralizing fins 54 keep the upper carrier 46 centered in the well casing 14. As shown in FIG. 3B, the protective sleeve 52 is somewhat longer than the carrier 46 and its lower end will be the first part of the upper completion to reach the packer 18. The protective sleeve 52 is too large to pass through the interior flow path 36 through the packer 18 and stops moving down when it contacts the top of the packer 18. Since the tubing 42 is still moving downhole, it applies force to the upper carrier 46 and shears the shear pin 94 allowing the upper carrier 46 to continue moving down and out of the protective sleeve 52.

As the upper carrier 46 exits the lower end of the protective sleeve 52, it passes through the packer 18 and enters the upper end of the lower carrier 34. After the orientation key 74 has exited the protective sleeve 52 and passed through the packer 18 and seal bore 102, its spring causes it to deploy into the extended position shown in FIG. 2B. As the upper carrier moves down into the lower carrier 34, the orientation key 74 will contact the scooped profile 110 of orientation sleeve 108. Regardless of the rotational orientation of the upper carrier 46 as it enters the lower carrier 34, the orientation key 74 will follow the profile 110 and cause the upper carrier to rotate to a desired angular position in which the upper connector 48 is rotationally aligned with the lower connector 32, at least within close tolerance.

As the upper carrier 46 continues moving downhole, two other alignment arrangements precisely align the upper connector 48 with the lower connector 32. The tubing extension 88 enters the upper portion 122 of the collar 112 and provides radial alignment of the connectors 48 and 32. The nose profile 86 surrounding the male connector 48 enters the complementary recess 119 in the collar 112. The nose profile 86 and recess 119 are preferably machined to close tolerance to provide a precise final rotational alignment of the upper connector 48 with the lower connector 32.

Downward movement of the upper carrier 46 relative to lower carrier 32 stops when the face 80 of the upper carrier 46 contacts a surface 113 (FIG. 5) of the collar 112. At that point, the upper connector 48 will have connected with lower connector 32 and formed operative connection or communication between the signal lines 30 and 44. The connectors 48 and 32 are positioned to make complete connection a short distance before the face 80 contacts the surface 113 of collar 112. The spring 72 is compressed by the final movement of the upper carrier 46, providing a continuing force keeping the connectors 48 and 32 operatively connected.

The commercially available connectors 48 and 32 include internal compartments filled with fluid, typically grease, which are adapted to flush away any foreign material as the connectors mate. In this downhole application, the well is normally filled with drilling or completion fluid which may be water or oil based and may include produced fluids such as crude oil, brine, etc. It would normally not be desirable for any conventional well fluids to enter or remain in the connectors 48 and 32. The fluid carried in the connectors will flush the undesirable fluids out as connection is made.

As noted above, the tubing extension 88 on the bottom of upper carrier 46 has an outer diameter that forms a close fit with the inner bore 122 on the upper end of the collar 112. While this is a close fit, it is not a fluid tight fit. At about the same time as the extension 88 enters the area 122, the seal body 50 on the upper end of upper carrier 46 enters the seal bore 102 on the upper end of lower carrier 34 and forms an essentially fluid tight fit, in part because of seals such as O-rings 51. Fluid located between the face 80 and nose area 86 of the upper carrier and the upper end of collar 112 is therefore forced to flow through the close space between the extension 88 and the bore 122 as the upper carrier moves further downward. As the upper carrier 46 moves down, the resistance to flow increases. This arrangement provides fluid damping of the downward motion of the upper carrier 46 as it reaches its lowermost position. This damping reduces the chance of mechanical damage which might be caused by a sudden impact of the upper carrier 46 with the lower carrier 34. The connectors 48 and 32 are relatively delicate as compared to the typical oil field tubulars that form most of the upper and lower completions and this damping of downward motion reduces the risk of damage. As the fluid is flushed out in this final damping of the relative motion, it may also assist in flushing undesirable materials from the connectors 48 and 32 just before they make initial contact.

In the disclosed embodiments, the signal lines 30 and 44 are optical fiber cables. Electrical cables have been used in downhole applications and connectors for electrical cables are available. Electrical cables and connectors may be used in place of or in addition to the optical fiber cables and connectors. Hydraulic lines have also been run downhole for operating downhole valves, motors, etc. and quick disconnects are available for hydraulic systems and may also be used in place of or in addition to the disclosed optical fiber cables and connectors. If desired, more than one set of connectors could be carried on the carriers so that more than one type of signal line may be connected downhole. Multiple types of connectors could be used side by side or in tandem. The present invention is directed primarily to the alignment mechanism which provides precise alignment between the connectors so that they may be properly connected without damage in the severe downhole environment, and not to the particular type of signal lines and connectors.

In some wells, downhole pressures may be able to provide sufficient upward force on the upper completion 40 to lift it up relative to the lower completion 22. If the amount of upward movement should exceed the compression of the spring 72, the connectors 48 and 32 might lose their operative connection. In such wells, it would be desirable to include a releasable latch between the upper carrier 46 and the lower carrier 32. Such a latch would preferable include a shear pin in the upper carrier 46 which would release the latch in response to sufficient upward force on the tubing 42. If the upper completion needs to be removed from the well, the shear pins can be replaced to put the upper completion back in original configuration for running back into the well.

In this embodiment, the upper carrier 46 carries a male connector and the lower carrier 34 carries a female connector. A reason for this choice is that in commercially available fiber optic connector systems, the female connector is larger in diameter than the male connector. As can be seen from the drawings, the upper carrier connector is carried outside the tubing 56 that forms the production flow path and the whole upper carrier must fit through the interior flow path 36 in the packer 18 mandrel 38. As the upper carrier connector size increases, the available production flow path is reduced in size. It is desirable that the upper carrier 46 connector be as small as possible, to provide the largest possible production flow path. Since the lower carrier connector 32 is attached below the packer 18 before installation, it does not have a limiting effect on the production flow path through the packer 18.

In alternate embodiments, the upper connecter 48 may be carried at least partially within the tubing 56 of the upper carrier in the run in configuration. Such an arrangement would permit a larger diameter for the production flow path through tubing 56 for a given diameter of interior flow path 36 through the packer 18 mandrel 38. The upper connector 48 could then be deployed axially after the upper carrier 40 has passed through the packer 18. This alternate embodiment would be more complex than the preferred embodiment, would be more expensive and would have a greater risk of damage and failure. This alternate embodiment would also include the alignment mechanisms of the disclosed embodiment. For these various reasons, the disclosed embodiment maintains the upper connector 48 in a fixed position relative to the upper carrier 46 throughout the run in and connection steps.

While the present invention has been illustrated and described with respect to particular embodiments, it is apparent that various modifications, substitutions, and additions may be made within the scope of the invention as defined by the appended claims.

What we claim as our invention is:

1. A well completion system, comprising:
a packer, the packer having a flow path,
a lower carrier having an upper end coupled to the packer flow path and having a lower carrier flow path adapted for flowing fluids produced from the well,
a lower signal line connector carried on the lower carrier,
a lower signal line operatively connected to the lower signal line connector,
an upper carrier having an upper carrier flow path adapted for flowing fluids produced from the well and a seal adapted for forming a substantially fluid tight seal with the lower carrier flow path, when said upper carrier is positioned within the lower carrier,
an upper signal line connector carried on the upper carrier,
an upper signal line operatively connected to the upper signal line connector,
an upper carrier alignment element carried on the upper carrier, and
a lower carrier alignment element carried on the lower carrier,
the upper carrier alignment element positioned to engage the lower carrier alignment element and align the upper connector with the lower connector in response to movement of the upper carrier into the lower carrier.

2. The well completion system of claim 1, wherein:
the upper carrier alignment element comprises an orientation lug carried on an outer surface of the upper carrier, and
the lower carrier alignment element comprises an orientation sleeve having a scooped profile carried on an inner surface of the lower carrier,
whereby upon movement of the upper carrier into the lower carrier, the orientation lug follows the scooped profile and rotates the upper carrier relative to the lower carrier to align the upper signal line connector and lower signal line connector.

3. The well completion system of claim 2, further comprising:
an alignment nose carried on the upper carrier,
an alignment recess in the lower carrier, the alignment recess being complementary with the alignment nose,
whereby, upon movement of the upper carrier into the lower carrier, the alignment nose enters the alignment recess and aligns the upper signal line connector and lower signal line connector.

4. The well completion system of claim 3, wherein:
the upper signal line connector is centered in the alignment nose, and
the lower signal line connector is centered in the alignment recess.

5. The well completion system of claim 2, further comprising:
a cylindrical surface on the outer surface of the upper carrier,
a cylindrical bore on an inner surface of the lower carrier,
the cylindrical surface and cylindrical bore positioned so that as the upper carrier moves into the lower carrier, the bottom of the cylindrical surface enters the top of the cylindrical bore before the upper signal line connector contacts the lower signal line connector,
whereby the cylindrical surface and cylindrical bore align the upper connector with the lower connector and damp movement of the upper carrier into the lower carrier.

6. The well completion system of claim 1, further comprising:
a spring coupled between the upper carrier and the upper signal line connector and positioned to be partially compressed in response to movement of the upper carrier into the lower carrier.

7. The well completion system of claim 1, wherein the upper signal line and the lower signal line are selected from one of: optical fiber cable, electrical cable and hydraulic flow line.

8. The well completion system of claim 1, wherein the upper signal line connector is a male connector and the lower signal line connector is a female connector.

9. A well completion system, comprising:
a lower completion comprising a packer, a first length of production tubing having an upper end coupled to the packer, and a lower signal line connector positioned below the packer,
an upper completion comprising a second length of production tubing and an upper signal line connector, the upper completion adapted to move the upper signal line connector down through the packer and make operative connection between the upper signal line connector and the lower signal line connector below the packer.

10. The well completion system of claim 9, further comprising:
an orientation lug carried on an outer surface of the upper completion, and
an orientation sleeve having a scooped profile carried in the lower completion,
whereby upon movement of the upper completion into the lower completion, the orientation lug follows the scooped profile and rotates the upper completion relative to the lower completion to align the upper signal line connector and lower signal line connector.

11. The well completion system of claim 9, further comprising:
an alignment nose carried on the upper completion,
an alignment recess in the lower completion, the alignment recess being complementary with the alignment nose,
whereby, upon movement of the upper completion into the lower completion, the alignment nose enters the alignment recess and aligns the upper signal line connector and lower signal line connector.

12. The well completion system of claim 11, wherein:
the upper signal line connector is centered in the alignment nose, and
the lower signal line connector is centered in the alignment recess.

13. The well completion system of claim 9, further comprising:
one or both of a sensor and an actuator carried on the first length of production tubing,
a lower signal line coupled between the lower signal line connector and the one or both of the sensor and the actuator,
an upper signal line coupled between the upper signal line connector and a surface location of the well,
the upper and lower signal lines and the upper and lower signal line connectors together forming a signal path between the surface location of the well and the one or both of the sensor and the actuator.

14. The well completion system of claim 9 wherein the upper signal line connector is carried on an outer surface of the second length of tubing, further comprising:
a protective sleeve carried on the second length of tubing at the location of the upper signal line connector, and
centralizers carried on the protective sleeve.

15. A method of completing a well, comprising:
coupling a packer to an upper end of a first length of production tubing,
coupling a lower signal line connector to the tubing below the packer,
positioning the packer, tubing and lower signal line connector in a well,
actuating the packer to form an annular seal between the production tubing and the well,
coupling an upper signal line connector to a second length of production tubing, lowering the second length of production tubing down the well,
connecting the second length of production tubing to the first length of production tubing, and
connecting the upper signal line connector to the lower signal line connector below the packer.

16. The method of completing a well according to claim 15, further comprising:
coupling an orientation lug to the second length of tubing,
forming a orientation profile on an inner surface of the first length of tubing,
whereby upon lowering the second length of production tubing down the well, the orientation lug follows the orientation profile and rotates the second length of tubing to align the upper signal line connector with the lower signal line connector.

17. The method of completing a well according to claim 15, further comprising:
forming an alignment nose on the second length of tubing,
forming an alignment recess in the first length of tubing, the alignment recess being complementary with the alignment nose, and
lowering the alignment nose into the alignment recess and thereby aligning the upper signal line connector and lower signal line connector.

18. The method of completing a well according to claim 15, further comprising:
positioning a protective sleeve around the second length of tubing at the location of the upper signal line connector, and
positioning centralizers on the protective sleeve,
whereby upon lowering the second length of production tubing down the well, the protective sleeve prevents damage to the upper signal line connector and the centralizers keep the second length of tubing centered in the well.

19. The method of completing a well according to claim 15, further comprising:
coupling one or both of a sensor and an actuator to the first length of production tubing,
coupling a lower signal line from the lower signal line connector to the one or both of the sensor and the actuator, and
coupling an upper signal line from the upper signal line connector to a surface location of the well,
whereby the upper and lower signal lines and the upper and lower signal line connectors together provide a signal path between the surface location of the well and the one or both of the sensor and the actuator.

20. The method of completing a well according to claim 15, further comprising:
forming a substantially fluid tight seal between the second length of production tubing and the first length of production tubing.
